(19) United States
(12) Patent Application Publication
(10) Pub. No.: US 2018/0073677 A1
(43) Pub. Date: Mar. 15, 2018

(54) FLEXIBLE SUPPORT AND CLOSUREAPPARATUS

(71) Applicant: John Joseph, Sacramento, CA (US)

(72) Inventor: John Joseph, Sacramento, CA (US)

(21) Appl. No.: 15/673,400

(22) Filed: Aug. 9, 2017

Related U.S. Application Data
(60) Provisional application No. 62/373,131, filed on Aug. 10, 2016.

(51) Int. Cl. F16M 13/02

(52) U.S. Cl. CPC F16M 13/02; E05C 19/00

(57) ABSTRACT

The present invention overcomes the disadvantages of the prior art by providing a flexible adjustable support and closure apparatus which includes a flexible strap and a locking head. The flexible strap has a series of spaced apertures formed therein. A first group of apertures extends from one end and over at least half of the strap, the first group serving to allow for adjustably forming an overlapped portion of the strap. A second group of apertures extends from an opposing end of the strap. A locking member has a central post terminating at opposing ends with radially extending, axially aligned discs sized for locking engagement with the apertures. A third axially aligned disc positioned intermediately along the axis of the post and also radially extending therefrom separates the opposing end discs so that apertures on either end of the strap may be selectively and discretely engaged and disengaged from said discs. The locking member includes a central bore adapted to receive a screw or equivalent fastening member. The arrangement is used as a support by overlapping the strap and locking in place a pair of the first apertures to form a loop which functions as a primary anchor for the support, with the locking member serving to secure the loop to a support surface, the end opposite of the loop secured to the support surface at a position most conducive to stably supporting an object. The apparatus is also used as a closure, and includes a locking member that can be reconfigured to fit various uses.

### CROSS REFERENCE TO RELATED APPLICATION

This application claims the priority date of provisional application Ser. No. 62/373,131, filed Aug. 10, 2016.

### BACKGROUND OF THE INVENTION

The present invention relates generally to support devices and methods for supporting objects onto vertical surfaces. More particularly, it relates to an improved adjustable support device which can also function as a closure for doors, gates, etc.

Support apparatuses for attaching objects to a vertical surface are known in the art and typically comprise some type of bracket assembly with several rigid support members configured to form the dual functions of vertical support and object retention. While these devices are generally functional they suffer from several drawbacks. First, they tend to require complicated anchoring systems to support them to the wall or other support surface and thus tend to do some damage to the wall. Secondly, they are not particularly portable in that they must be carefully removed and disassembled and are also bulky. Also, they cannot be easily configured to reliably support irregularly shaped objects.

U.S. Pat. No. 6,581,885 issued to Polad discloses a device which has a flexible strap for containing a cable, with a flat rigid portion attached thereto for support on a vertical surface. The rigid portion includes a plurality of pegs sized to engage mating holes on the strap to adjust to the size of the cable to be supported. Polad suffers from the drawback in that the rigid portion is relatively bulky and cannot be collapsed for storage. Also, the vertical portion orients the strap to limit the position of the article to be supported to a position substantially perpendicular to the rigid portion.

None of the above inventions and patents, taken either singly or in combination, is seen to describe the instant invention as claimed.

### SUMMARY OF THE INVENTION

The present invention overcomes the disadvantages of the prior art by providing a flexible adjustable support and closure apparatus which includes a flexible strap and a locking head. The flexible strap has a series of spaced apertures formed therein. A first group of apertures extends from one end and over at least half of the strap, the first group serving to allow for adjustably forming an overlapped portion of the strap. A second group of apertures extends from an opposing end of the strap. A locking member has a central post terminating at opposing ends with radially extending, axially aligned discs sized for locking engagement with the apertures. A third axially aligned disc positioned intermediately along the axis of the post and also radially extending therefrom separates the opposing end discs so that apertures on either end of the strap may be selectively and discretely engaged and disengaged from said discs. The locking member includes a central bore adapted to receive a screw or equivalent fastening member. The arrangement is used as a support by overlapping the strap and locking in place a pair of the first apertures to form a loop which functions as a primary anchor for the support, with the locking member serving to secure the loop to a support surface, the end opposite of the loop secured to the support surface at a position most conducive to stably supporting an object. The apparatus is also used as a closure, and includes a locking member that can be reconfigured to fit various uses.

It is an object of the invention to provide a flexible adjustable support and closure apparatus which includes a matching pair of rigid anchoring members.

It is an object of the invention to provide a flexible adjustable support and closure apparatus wherein said anchoring members have at least two locking discs coupled by an axial post.

It is an object of the invention to provide a flexible adjustable support and closure apparatus wherein the size of the locking discs is varied according to function.

It is an object of the invention to provide a flexible adjustable support and closure apparatus which has opposing ends where one or both ends can be self reinforced using the anchoring members.

It is another object of the invention to provide a flexible adjustable support and closure apparatus having anchoring members which can be used to form a loop to allow for engagement about a horizontal support member.

Finally, it is a general object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 shows a perspective view of the apparatus securing an object to a vertical surface.

FIG. 2A shows a plan view of the strap of the cable tie arrangement.

FIG. 2B shows a cross section detailing the reinforcement of holes in the strap of FIG. 2A.

FIG. 2C shows an illustration of the loop and capture method of using the strap and anchoring members.

FIG. 3A shows a cross section of a first embodiment of the anchoring member of the apparatus.

FIG. 3B shows a cross section of a second embodiment of the anchoring member of the apparatus.

FIG. 3C shows a cross section of a third embodiment of the anchoring member of the apparatus.

FIG. 3D shows a cross section of a fourth embodiment of the anchoring member of the apparatus.

FIG. 4 shows a perspective view of the apparatus deployed to secure a gate.

FIG. 5 shows a perspective view of an alternative placement of the apparatus deployed to secure a gate or other hinged planar member in a closed position.

FIG. 6 shows a plan view, partly in section, of an alternative embodiment of the anchoring member having a rounded locking head.

FIG. 7 shows a side perspective view of the embodiment of FIG. 5, illustrating the anchoring member.

FIG. 8 shows a perspective view of the embodiment of FIG. 5, illustrating the apparatus securing a swinging gate.

FIG. 9 shows a plan view of the embodiment of FIG. 5 without an anchoring screw.

FIG. 10 shows a plan view of the embodiment of FIG. 5 used to form a loop about a horizontal support member.

### DETAILED DESCRIPTION

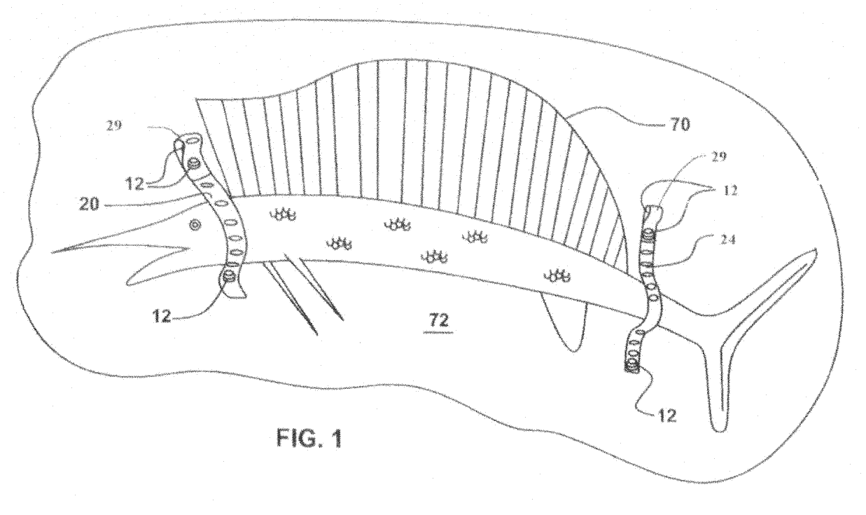

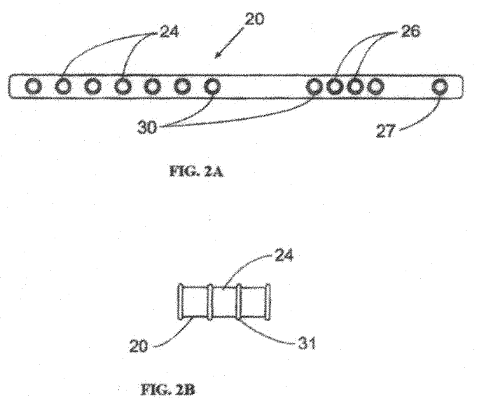

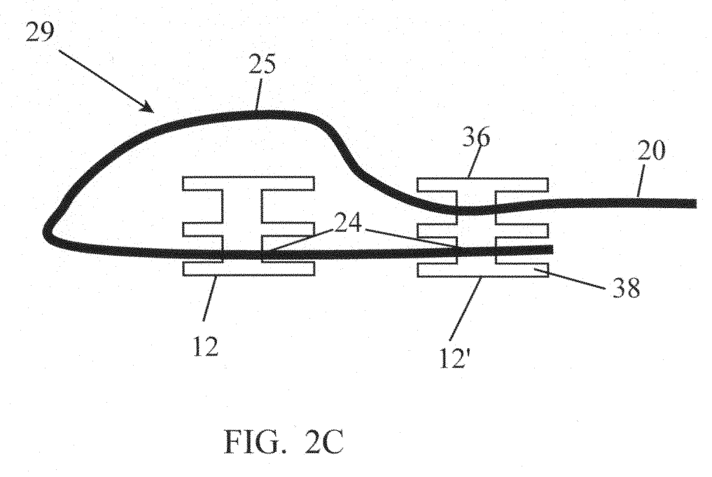

The present invention, generally indicated by the numeral 10, is shown in FIGS. 1-5 and can be seen to include an anchoring member 12 and a strap 20 as the primary components. The strap 20 is preferably made of rubber or other elastic material. High strength plastics or other flexible material may also be used. Preferred material for the strap 20 includes EPDM® or TPE® materials. The TPE® material may be used to create straps 20 in many different colors, which may be used for color-coding where, e.g., each size has a distinctive color. Two groups of apertures 24, 26 are formed extending from the opposing ends of the strap 20. A separate aperture 27 serves to allow for the formation of a single loop 25 of strap 20 using the anchoring member 12 to form an anchoring end 29 for the apparatus 10 as can be seen in FIG. 1 and FIG. 2C. The first group of apertures 24 allow for adjustably securing the strap 20 about the article 70 to be supported. Tabs (not shown) may be formed at opposing ends of the strap 20, the tabs serving to prevent failure of aperture 27 at one end of the strap, and the aperture 24 closest the opposite end of the strap 20. Preferably, the tabs are formed whenever the TPE® material is used.

Referring particularly now to FIGS. 2A and 2B it can be seen that both sets of apertures 24, 26, and aperture 27 include a reinforcing bead 30 to reduce the possibility of strap 20 failure due to rupturing of the material proximate the aperture. Apertures 26 and 27 may optionally be formed without beads 30, as the strap 20 portions proximate these apertures may not be subject to the same loading and torsional stresses as apertures 24, depending upon the particular application. To ensure that the strap 20 remains securely attached to anchoring member 12 under high stress conditions, the apertures 24, 26 are substantially smaller than end discs 36, 38 of the anchoring member 12.

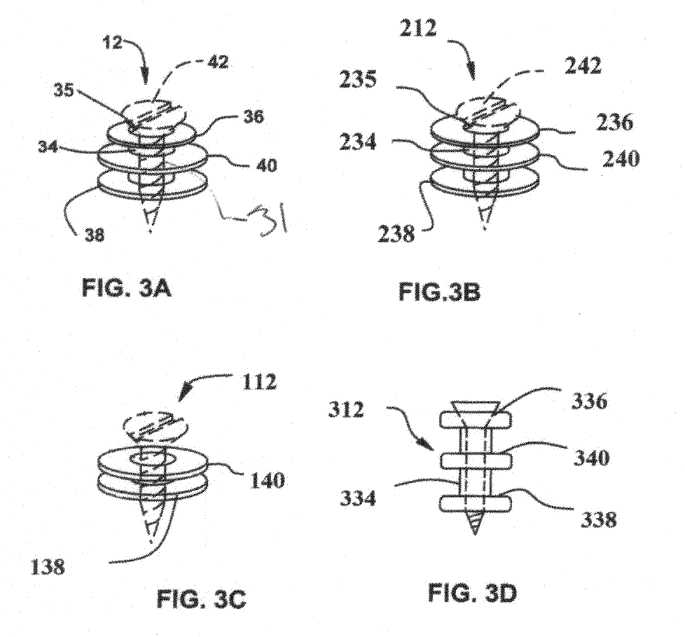

The anchoring member 12, as shown in FIG. 3A, includes an outer sleeve or portion 31 which is formed of a central post 34 with an axial bore 35 that connects opposing end discs 36, 38 as well as central disc 40, and an inner portion 42 which is a fastener such as a screw or nail. In a first embodiment, end disc 38 and central disc 40 have the same diameter, but end disc 36 has a diameter approximately 25% smaller than discs 38 and 40. The size and number of discs can vary according to function as discussed in more detail below. Also, the discs 36, 38, 40 may be slightly elliptical or any other gem An integral construction may be used to form the outer portion 31 of anchoring member 12, the outer portion 31 preferably being formed of unitary construction, e.g., by molding. Any rigid, durable material may be used to form the anchoring member 12 such as a hardened plastic. The axial bore 35 extends through the anchoring member 12, the bore sized to receive a fastener 42 such as a wood screw or the like, the fastener 42 to be selected in accordance with the surface 44 to which the device is secured. Preferably, one end of the bore 35 is chamfered to guide the fastener 42 into and through member 12. The annular spaces 37, 39 between discs 36, 40 and 38 40 are spaced in accordance with the thickness of the strap, specifically, the spaces are slightly greater than twice the thickness of the spaces 37, 39 to allow for the formation of a loop 25 of strap as shown in FIG. 2C.

A key aspect of the invention is the flexibility of the components of the apparatus 10 when used to support positioning objects on vertical surfaces. To that end, apparatus 10 can be applied, in various configurations, to accomplish multiple tasks. For example, a pair of anchoring members 12 may be deployed in laterally spaced relation to secure paintings, posters and other framed items in a standalone mode (without straps 20), with the space 39 between discs 38, 40 serving as a channel or groove within which cables attached to a framing member may be seated. Member 12 may also be used with a pegboard to hang articles. Members 12 may be used with straps 20 to hang objects from overhead (horizontal) supports. Thus it can be seen that the anchoring member 12 may be used as a general purpose anchoring member for supporting various types of articles onto vertical surfaces such as walls.

With particular reference now to FIGS. 1 and 2C, the apparatus 10 is typically deployed on a vertical surface such as a wall, gate, cabinet door, etc. An anchor point 29 is established by inserting two anchoring members 12 and 12′ into a vertical surface such as a wall 72 using screws 42 and capturing adjacent strap apertures 24 onto the anchor member disc 38 closest to the object supported, then folding a loop 25 of the strap 20 over one of the anchoring members 12, and capturing the strap 20 with opposing end disc 36 of the anchoring member 12′ as shown in FIG. 1 and illustrated diagrammatically (without the screws 42) in FIG. 2C. The anchoring members 12, 12′ may then be secured to the surface by inserting screw 42 into and through anchoring member 12, and then into the surface 72. A suitable length of strap 20 is then placed over the object to be supported and an opposing attachment point 52 is selected, which point may be maintained by simply applying the strap about an end disc 38, after securing the screw 42 of the anchoring member 12 into the surface as described above.

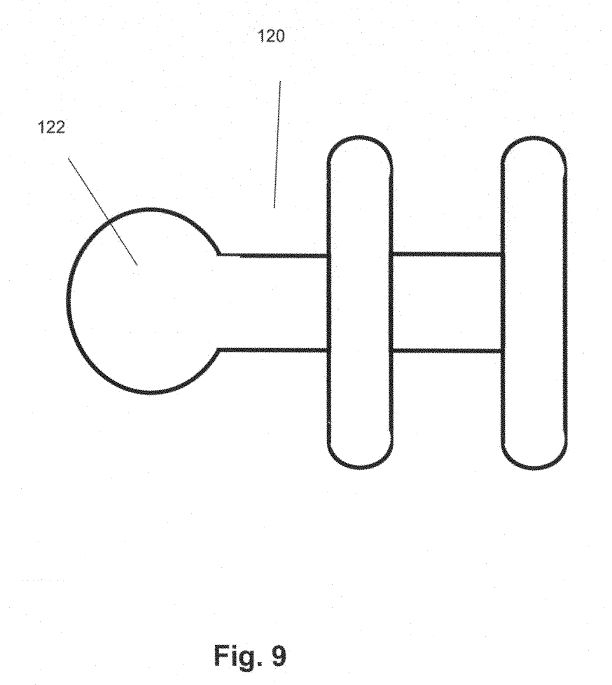

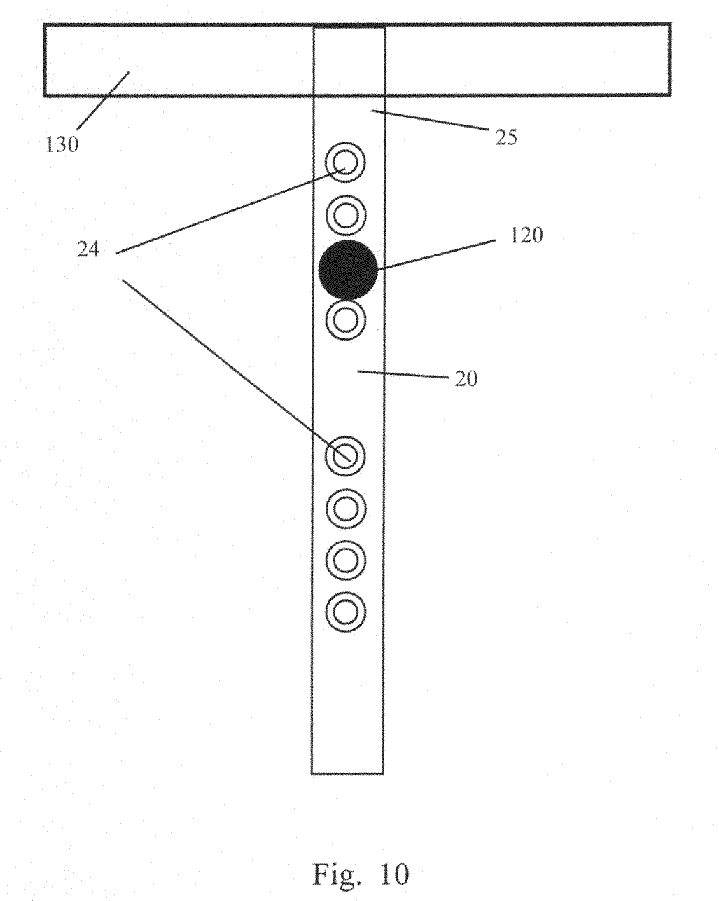

Loop 25 may optionally be formed using anchoring members 12, 12′ without screws as shown in FIG. 2C. The loop 25 may be used to attach strap 20 to a rod 130 (See FIG. 10) or other horizontal support member, the apertures 24 of the strap 20 allowing the user to insert curtain hooks or the like therethrough. The strap 20 configured as a loop 25 can be used to create multiple hanging attachment points, corresponding to the number of accessible apertures 24 of the strap 20 from any securely attached elongated horizontally extending support member. The strap 20 is vertically disposed when hung from a horizontal member with each aperture 24 serving as an attachment point for, e.g. a coat hanger. When used in this fashion, anchoring member 12′ preferably has a rounded head for ease of disconnection as shown in FIG. 9, the rounded head replacing locking head 38. If the loop 25 is not to be attached to a vertical surface, anchoring member 12′ may be used to form the loop while the other anchoring member 12 is omitted.

As mentioned above, the apparatus 10 may be configured for many uses, and can be adapted accordingly. Referring now to FIG. 1, an exemplary use is shown. A relatively large object 70 is supported by two of the apparatuses 10. It can be seen in this configuration that three anchoring members 12 are used per strap 20. The uppermost or primary weight bearing end of the strap 20 is looped with a first anchoring member 12 positioned within the loop and secured to a surface 72 through a single strap aperture, and a second anchoring member 12 is secured to the surface 72 through two strap 20 apertures thus forming the loop and also serving as the primary weight bearing attachment point. An additional anchoring member 12 is used as the lowermost attachment to surface 72, in a manner as described above. It can be noted that the apparatus 10 is flexible in that as many or as few straps 20 and anchors 12 as needed can be used depending upon the weight or size of the object to be supported, and may be oriented as necessary depending on the weight, shape, and center of gravity of the object to be supported, unlike conventional brackets which typically provide support only in either a horizontal or vertical plane. Flexible straps 20 allow for conformance to the contour of virtually any object.

Also as mentioned above, an anchoring member 112 with only two discs, 138, 140 may be used as shown in FIG. 3C. This embodiment of the anchoring member 112 is expedient when used as a non or limited weight bearing attachment and allows for quick release of the apparatus. Such an anchoring member may be used for example in the place of lowermost anchoring member 112 as shown in FIG. 1. Discs can be all large diameter to increase resistance to accidental disengagement when heavy objects are supported or movement of the supported article is anticipated. An all large diameter disk anchoring member 212 is shown in cross section in FIG. 3B. Member 212 includes an outer sleeve or portion 231 which is formed of a central post 234 with an axial bore 235 that connects opposing end discs 236, 238 as well as central disc 240, and an inner portion 242 which is a fastener such as a screw or nail. A fourth embodiment of the anchoring member 312 is shown in FIG. 3D, and can be seen to have three discs 336, 338, and 340 of the same diameter, with more axial spacing and slightly thicker discs with rounded edges 239. The discs 336, 338, and 340 are about 25% smaller, the smaller diameter discs 336, 338, 340 allows for easier manipulation of the strap 20 onto the anchoring member 312, to facilitate use by persons with limited hand strength.

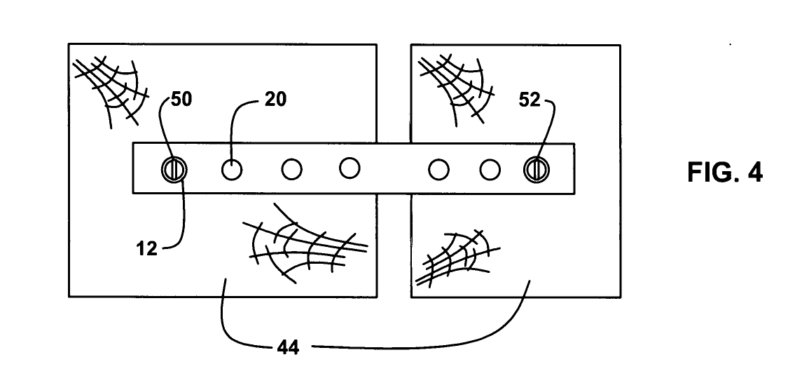

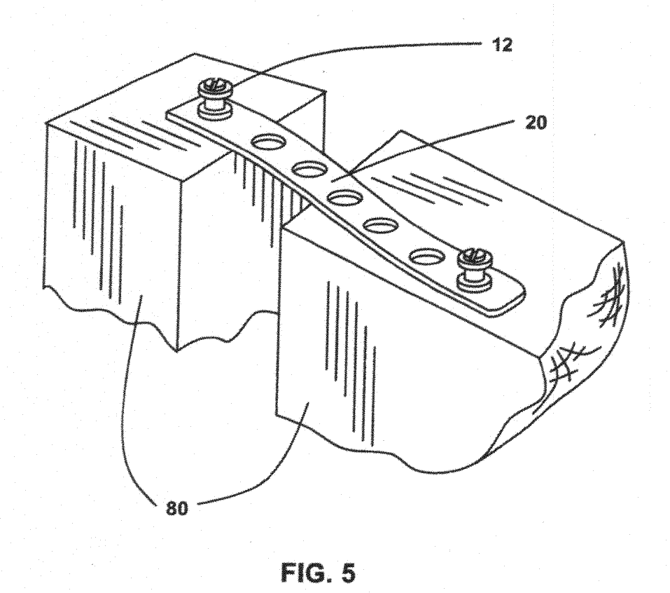

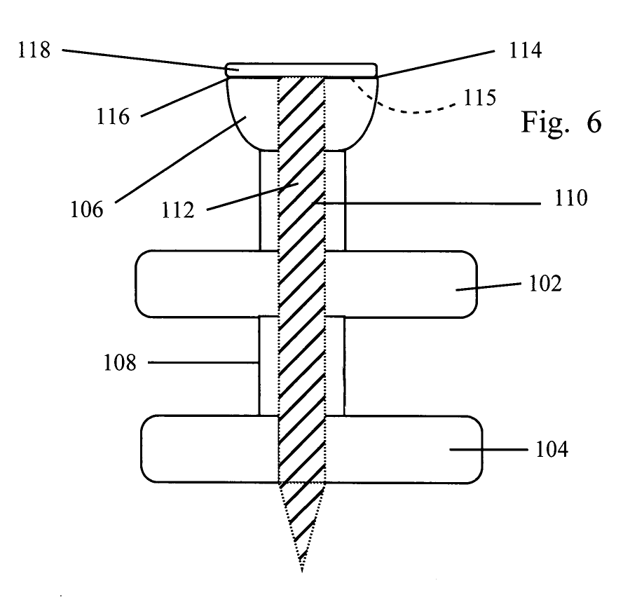

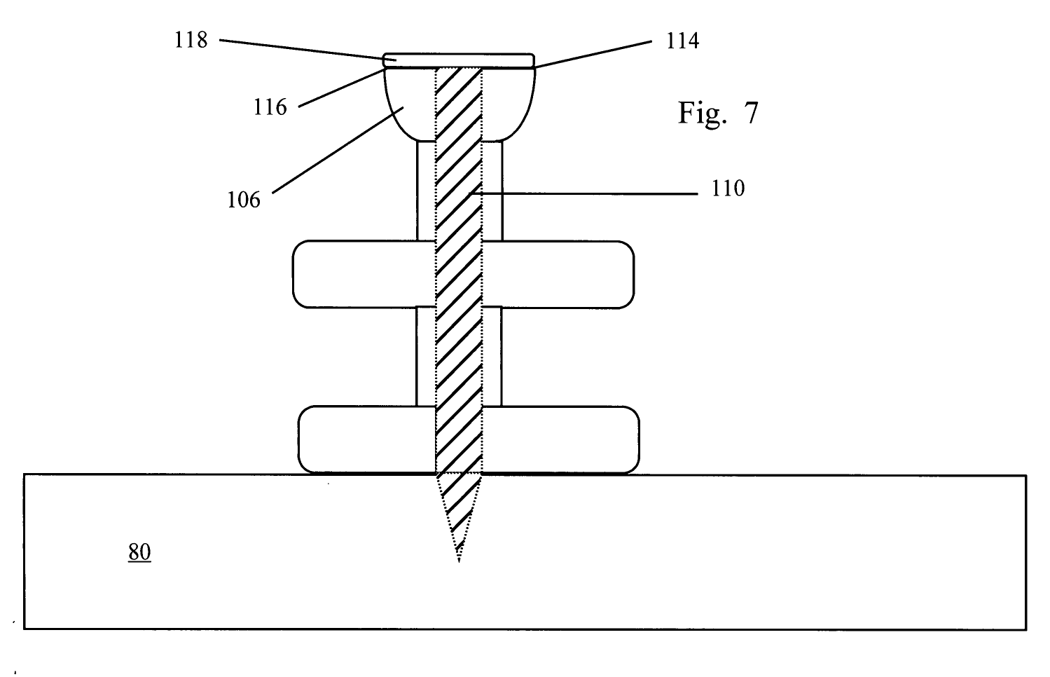

The apparatus 10 may also be used as a closure as shown in FIGS. 4 and 5. The strap 20 may be looped to align two of the apertures through which an anchoring member 12 is inserted to establish an anchoring point 50, the member then secured to an upper edge vertical surface 44 of a door, fence post etc. Another anchoring member 12 may then be inserted into an adjacent vertical surface 44 of, e.g. a gate 80, which is movable between an open and shut position. A selected aperture of strap 20 is then engaged with the top disc of the anchoring member 12 to form a release point 52 of a closure. A two disc anchoring member 12 may be used for this application. An advantageous feature of this arrangement is that the apparatus may be attached at any position on the gate 80 or door to be secured, and is thus easily placed out of the reach of small children or animals. For example, for an outdoor fence, the apparatus may be positioned at the top of a fence post as shown in FIG. 5, with the release point positioned at the top of the gate to be secured. This arrangement would also allow access from either side of the gate 80. It should be noted that this type of closure does not require alignment of two rigid closure members, which can often be a problem with outdoor fences as warping and other environmental conditions can cause the closure member to get out of alignment resulting in expensive or inconvenient repairs. Preferably, a quick release type of anchoring member is used, the member having a rounded or tapered head as shown in FIGS. 6-9 and discussed below.

Referring now to FIGS. 6-10 a fifth embodiment of the anchoring member is shown. In this embodiment, generally indicated by the numeral 100, two equal diameter discs 102, 104 and an axially aligned spherical latching member 106 form the member 100. As can be seen from the cross section, the member 100 has a hollow elongated main body 108, within which a screw 110 or other suitable elongated fastening member is positioned. As in the previous embodiments, the screw 110 may be inserted into and through the central bore 112 of the main body, and into a surface.

The latching member 106 has a substantially spherical shape with a flattened top end 114. The flattened top 114 essentially forms an annular surface or seat 115 to allow for flush engagement with the underside 116 of the screw head 118. This configuration prevents the strap 20 from snagging on the underside 116 of the screw head 118. Preferably the screw head 118 has rounded edges to further facilitate removal of the strap. A shape which is smooth and allows for a gradual increase in dimension from both the top and bottom directions (which corresponds to removing and attaching the strap). Thus an ovoid shape would be effective but any shape with jagged or protruding edges would not.

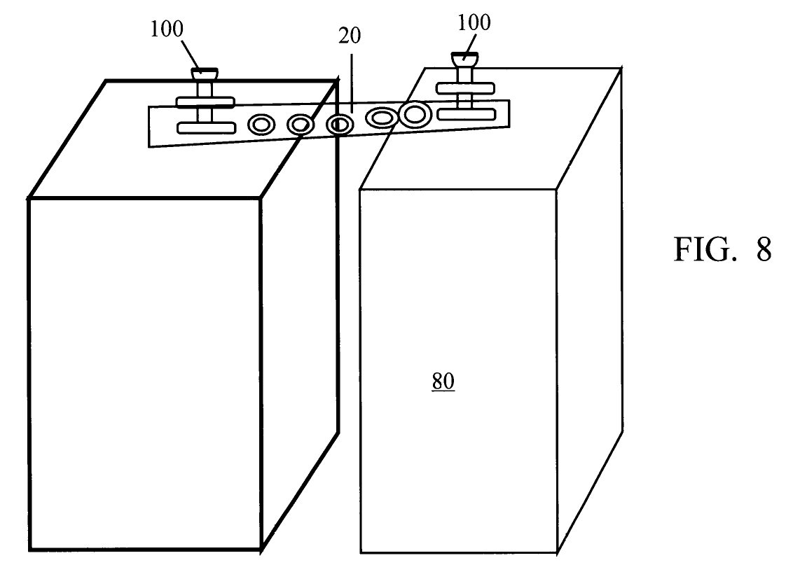

As can be seen in FIG. 8, the use of a flexible strap 20 secured between two anchoring members 100 allows for great flexibility to form a temporary or permanent closure. The apparatus 10 is especially useful in situations where either the moving or stationary component of the item (e.g., the gate or cabinet door for which a closure is needed) is subject to displacement, warping, or the like as discussed above. The anchoring members 100, unlike a rigid closure, can be fastened anywhere on the door or gate, even at the top of the gate as in FIG. 8 allowing access from both sides of the gate.

Referring now to FIGS. 9 and 10, a locking member 120 having a rounded head 122 is shown. Rounded head 122 corresponds to locking head 36 of anchoring member 12′ as shown in FIG. 2C and thus locking member 120 may be used in place of anchoring member 12′ for forming stand alone, i.e., not anchored, loops 25. This locking member 120 may be used to form quick release loops 25 as the rounded head 122 allows for easier disengagement of the strap as described above. The other anchoring member 12 of FIG. 2C may be removed if the loop 25 is not to be anchored to a surface as discussed above. It can be appreciated that the quick release loops 25 have many uses. For example, the loop 25 may be used to facilitate hanging objects from a horizontally extending rod 130 for example, as discussed above and shown in FIG. 10. It can be seen in this configuration that a number of vertically disposed strap apertures 24 are available, allowing the apparatus 10 to be used to facilitate the display of a number of objects having hooks as might be seen in a retail display. Thus, a single horizontal bar 130 can be adapted to hang a number of items using a number of loops 25 without the use of nails or other hardware. The loop 25 may also be used to bundle cables, or to provide a weight bearing connecting strap 20 for connection to any number of items.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

What is claimed is:

1. A support and closure apparatus comprising:
a flexible strap having a plurality of spaced apertures formed therein;
at least two anchoring members, each of said anchoring members having an outer sleeve and an inner fastening element, said outer sleeve formed of at least two discs connected by a hollow shaft sized to receive the fastening member, said discs sized for insertion into and through said spaced apertures to secure said strap, each of said anchoring members having a rounded capture member formed at one end.

2. The apparatus of claim 1 wherein said rounded capture member has an oval cross section.

3. The apparatus of claim 2 wherein said capture member increases in width from both top and bottom, having a maximum width approximately at a mid-point between top and bottom.

4. The apparatus of claim 1 wherein said capture member has a top and bottom, the top of said capture member having an annular seat formed therein.

5. The apparatus of claim 4 wherein said fastener has a head portion sized for flush engagement with said annular seat when said fastener is fully inserted into and through said hollow shaft.

6. The fastener of claim 5 wherein said fastener head portion has rounded side edges.

7. A support and closure apparatus comprising:
a flexible strap having a plurality of spaced apertures formed therein;
a locking member, each of said locking members formed of at least two discs connected by a shaft, said discs sized for insertion into and through said spaced apertures to secure said strap, said locking member having a rounded capture member formed at one end, whereby a loop can be formed in said strap using said locking member.
